(19) United States
(12) Patent Application Publication
(10) Pub. No.: US 2012/0259587 A1
(43) Pub. Date: Oct. 11, 2012

(54) Method and Device for Determining Diagnoses

(75) Inventors: Christian SANNINO, Toulouse (FR); Fabien KUNTZ, Toulouse (FR); Eric LAURENT, Colomiers (FR); Sébastien DUBOIS, Scionzer (FR)

(73) Assignee: THALES, Neuilly-sur-Seine (FR)

(21) Appl. No.: 13/441,613

(22) Filed: Apr. 6, 2012

(30) Foreign Application Priority Data
Apr. 8, 2011 (FR) 11 01088

(51) Int. Cl. G06F 15/00

(52) U.S. Cl. 702/185

(57) ABSTRACT

A method for determining diagnoses for a system having a plurality of pieces of equipment, the equipment being adapted to transmit signals indicating its operating state, includes the following steps: acquiring observations based on signals transmitted by the equipment of the system under diagnosis, and determining a global situation based on the acquired observations and predetermined failure trees associated with these observations, wherein a failure tree describes the relations between an observation and root causes, and a root cause indicates a failure in a piece of equipment; determining connected situations, a connected situation being a set of observations which, when considered in pairs, have at least one common root cause in their failure tree; determining partial diagnoses on the basis of each of the connected situations, the diagnoses including root causes associated with observations signalling a failure; and, displaying the diagnoses.

### CROSS-REFERENCE TO RELATED APPLICATION

This application claims priority to foreign French patent application No. FR 1101088, filed on Apr. 8, 2011, the disclosure of which is incorporated by reference in its entirety.

### FIELD OF THE INVENTION

The invention relates to failure diagnosis in systems, particularly in avionic systems.

### BACKGROUND

The systems in question include a plurality of components communicating with each other and with the external environment by means of a physical network. The whole of the equipment, including the network, forms a system known as a system under diagnosis.

Methods of diagnostic searching include the method known as “model-based reasoning”, which is based on the processing of sets of logical propositions.

The expected behaviour of a component of a system is described by means of a logical proposition expressing the relations between its input and output values, or between its failures and the external effects of its failures.

The structure of the system in which a component is used is also described by a set of logical propositions. This set of logical propositions is called a model.

In the general case, a failure is detected by comparing the input and output values of the components observed in practice with the values predicted by the model (this is known as the method of failure detection by residuals). If these values are different, a set of events (or “set of observations”) is generated, each event signifying the presence of the observed failure.

The relations between an observation, a failure and a set of possible causes (or “ambiguity group”) are established by means of logical propositions.

Thus, by way of example, we shall consider the relation between the ambiguity group {a1, a2, a3} and the failure P resulting from one or more possible causes a1, a2 or a3 in the ambiguity group. This relation can be expressed by the logical proposition

P=a1+a2+a3,

where the sign “+” represents the logical connector “OR”.

This logical proposition therefore signifies that the failure P is the result of the occurrence of a1 or a2 or a3.

In the same way, we can define a failure Q, associated with the ambiguity group {b1, b2, b3}, which can be expressed as Q=b1+b2+b3.

The set of observed effects is referred to as the “situation” in the remainder of this text. A situation S in which the simultaneous presence (called the “combination”) of the failures P and Q is observed can be expressed as S=P•Q, where the sign “•” denotes the logical connector “AND”. Consequently this logical proposition signifies that the situation S is the result of the simultaneous observation of the failures P and Q.

The simultaneous presence of the failures P and Q results in the combination of their respective ambiguity groups, producing a new ambiguity group with two causes, {{a1•b1}, {a1•b2}, {a1•b3}, {a2•b1}, {a2•b2}, {a2•b3}, {a3•b1}, {a3•b2}, {a3•b3}}

This can also be expressed by the logical proposition

P•Q=(a1•b1)+(a1•b2)+(a1•b3)+(a2•b1)+(a2•b2)+(a2•b3)+(a3•b1)+(a3•b2)+(a3•b3)

This form of expression is the result of the development of the expression P•Q according to the rules of Boolean algebra, generally performed by “SAT solver” methods, designed for this type of search.

In known maintenance systems, the simultaneous presence of a plurality of failures causes problems. This is because the maintenance system presents each pair of causes in the ambiguity group to a maintenance operator. The maintenance operator is therefore required to eliminate the doubt in an ambiguity group of double failures; in the present case, there are 9 pairs of ambiguities. In a real system, the number of pairs may be very high.

Furthermore, calculations with SAT solver method, used on combinations such as that described above, generally require excessive computing time or volumes of memory exceeding the capacities of computers.

Patent application US2010/0100259 discloses a diagnostic method based on logical relations. However, this method does not include any specific processes for simplifying the calculation in the case of multiple failures.

### SUMMARY OF THE INVENTION

The invention is intended to overcome the aforementioned problems by proposing a method for determining diagnoses, comprising a special process intended to reduce the number of ambiguities (in other words the number of combinations of possible causes) in the case of multiple failures.

For this purpose, the invention proposes a method of determining diagnoses for a system having a plurality of pieces of equipment, the equipment being adapted to transmit signals indicating its operating state, characterized in that it includes the following steps:
a step of acquiring observations based on signals transmitted by the equipment of a system under diagnosis, and of determining a global situation based on the acquired observations and predetermined failure trees associated with these observations, wherein a failure tree describes the relations between an observation and the root causes, and a root cause indicates a failure in a piece of equipment,
a step of determining connected situations, a connected situation being a set of observations which, when considered in pairs, have at least one common root cause in their failure tree,
a step of determining partial diagnoses based on each of the connected situations, the diagnoses including root causes associated with observations signalling a failure,
a step of displaying the diagnoses.

The invention describes a minimal diagnostic search method for the efficient performance of the operations of eliminating doubt (also known as trouble shooting operation) in the case of multiple failures. The operations of eliminating doubt are performed by a maintenance operator who examines, in succession, the causes diagnosed as the origins of the observed failures.

The invention proposes a representation of the diagnosis which limits the number of ambiguities that have to be investigated by the operator. In the preceding example, the method according to the invention presents 2 ambiguity groups, each composed of 3 single ambiguities, instead of 9 pairs of ambiguities.

The invention describes a minimal diagnostic search method for the efficient performance of the operations of eliminating doubt in the case of multiple failures. This result is achieved by means of a preliminary processing of the logical proposition, the effect of which is to prevent the development of all the possible combinations of causes. Instead, the result is reduced to certain combinations of ambiguity groups.

The method according to the invention also enables calculations to be carried out more rapidly while requiring fewer memory resources. This is achieved by representing Boolean expressions by means of binary decision diagrams (BDD), used to represent failure trees.

According to a characteristic of the invention, the step of determining connected situations includes the following sub-steps:
determination of a reduced failure tree based on the global situation and on observations indicating non-failures, the reduced failure tree being produced by removing the causes associated with non-failure observations from the global situation,
a step of partitioning for the purpose of determining sub-trees of failures which do not share any root causes.

According to a characteristic of the invention, the method also includes a preparation phase for determining a set of failure trees associated individually with each of the observable effects based on a description of the system, these trees being stored in the database of predetermined trees.

According to a characteristic of the invention, the preparation phase includes the following steps:
for each observable effect:
the generation of a failure tree based on a description of the system under diagnosis, and the recording of the generated tree in the database of failure trees,
the extraction of an ambiguity group from the generated failure tree and the recording of the ambiguity group in the database of failure trees.

According to a characteristic of the invention, the display is divided into a plurality of sections, each of the sections including diagnoses having an identical number of simultaneous causes giving rise to the observed failure.

According to a characteristic of the invention, the display also includes a supplementary space for the display of masked ambiguity groups.

The invention also relates to a device for determining diagnoses for a system having a plurality of pieces of equipment, the equipment being adapted to transmit signals indicating its operating state, characterized in that it includes:
means for acquiring observations based on signals transmitted by the equipment of the system under diagnosis;
means for determining a global situation based on the acquired observations and on predetermined failure trees associated with these observations, a failure tree describing relations between an observation and root causes, a root cause indicating a failure of a piece of equipment;
means for determining connected situations, a connected situation being a set of observations which, when considered in pairs, have at least one common root cause in their failure tree;
means for determining partial diagnoses based on each of the connected situations, the diagnoses including root causes associated with observations signalling a failure;
means for displaying the diagnoses.

### BRIEF DESCRIPTION OF DRAWINGS

The invention will be more clearly understood and other advantages will become apparent in the light of the detailed description provided by way of non-limiting example and with the aid of the drawings, in which:

FIG. 1 shows an example of ambiguity groups associated with observations.

FIG. 2 shows an example of a set of equipment adapted to transmit signals indicating its operating state.

FIG. 3 shows a diagram of a method according to the invention.

FIG. 4 shows a diagram illustrating the steps of the preparation phase.

FIG. 5 shows the details of the steps of acquiring and determining connected situations.

FIG. 6 shows an example of a tree before and after partitioning.

FIG. 7 shows a diagram of the steps of determination of partial diagnoses and fusion.

FIG. 8 shows a first example of a display according to the invention.

FIG. 9 shows an example of a system under diagnosis.

FIG. 10 shows a second example of a display according to the invention.

### DETAILED DESCRIPTION

The method for determining diagnoses is applicable to systems including a plurality of pieces of equipment. The equipment is adapted to transmit signals indicating its operating state.

An example of such equipment is avionic equipment which is generally provided with a maintenance assistance function, known as “BITE”, an abbreviation for “Built In Test Equipment”. This function serves to provide a more or less detailed report on the operating state whenever it has triggered an alert indicating non-availability of its principal flight safety function, this report being designed for inclusion in a post-flight report (PFR) or last leg report (LLR) generated for use by maintenance personnel on the ground.

Failures are losses of service or interruptions of service that may occur in a piece of equipment. One failure may be caused by another failure. The search for the cause of a failure is an essential element in any action to restore the system to working order. If the search for the cause of a failure is no longer necessary, the last failure is called the “root cause”. A root cause can be a hardware failure, a software error, or a state of the system's environment which is incompatible with the operating mode of the system. A classification of failures is provided in: Fundamental Concepts of Dependability: Third Information Survivability Workshop, Boston (Avizienis, A., Laprie, J.-C., & Randell, B. (2000)).

These failures are observed via their “effects”. The effects can originate from a plurality of causes. When an effect is observed, therefore, there is an ambiguity concerning the origin of the failure. The set of root causes which may give rise to an effect is called the “ambiguity group” of this effect.

In the case of a single failure, the observation of all the resulting effects (the term “combination of observations” is used in this case) leads to the development of a diagnosis which generally identifies an ambiguity group.

In the case of multiple failures, the combination of observations leads to a combination of more than one ambiguity group, resulting in the development of a diagnosis which generally identifies a set of groups of simultaneous causes. The term “group of simultaneous causes” denotes a set of causes which, when occurring simultaneously, lead to the observation of multiple failures.

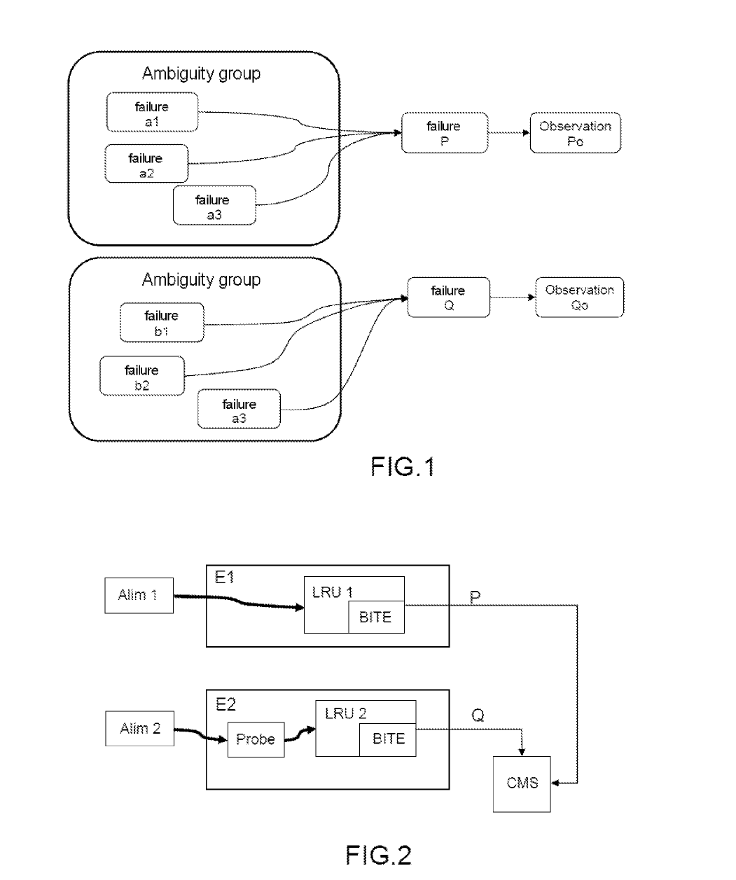

FIG. 1 shows an example of ambiguity groups associated with observations. The drawing shows:
a first observation Po of a first failure P associated with a first ambiguity group comprising the failures a1, a2 and a3, and
a second observation Qo of a second failure Q associated with a second ambiguity group comprising the failures b1, b2 and b3.

The simultaneous presence of the failures P and Q leads to the combination of the associated ambiguity groups, and produces a new ambiguity group of double failures which can be expressed by the logical proposition P•Q=(a1•b 1)+(a1•b2)+(a1•b3)+(a2•b1)+(a2•b2)+(a2•b3)+(a3•b1)+(a3•b2)+(a3•b3)

FIG. 2 shows another example of a set of equipment adapted to transmit signals indicating its operating state. The signals are received by a maintenance computer CMS using the method according to the invention. The first piece of equipment El comprises a first computation unit LRU1 (for Line Replaceable Unit), comprising a maintenance function BITE, and supplied by a first power supply. A second piece of equipment E2 comprises a second computation unit LRU2 comprising a maintenance function BITE. The second piece of equipment also comprises a probe (denoted “Probe”) for supplying measurements such as altitude, temperature or other measurements to LRU2.

The BITE of the first computation unit LRU1 transmits a message P signifying that either the power supply Alim1 has failed or the computation unit LRU1 has failed, which can be expressed as P=Alim1+LRU1.

The BITE of the second computation unit LRU2 transmits a message Q, signifying that the power supply Alim2 has failed or the computation unit LRU2 has failed or the measurement supplied by Probe has failed, which can be expressed as follows:

Q=LRU2+Probe+Alim2

The observation of P and Q will lead to P•Q =(LRU2+Probe+Alim2)•(LRU1+Alim1), or, by developing the expression,

P•Q=(LRU1•LRU2)+(LRU2•Alim1)+(Probe•LRU1)+(Probe•Alim1)+(Alim2•LRU1)+(Alim1•Alim2).

The invention can reduce the complexity of processing and presenting a diagnosis of multiple failures.

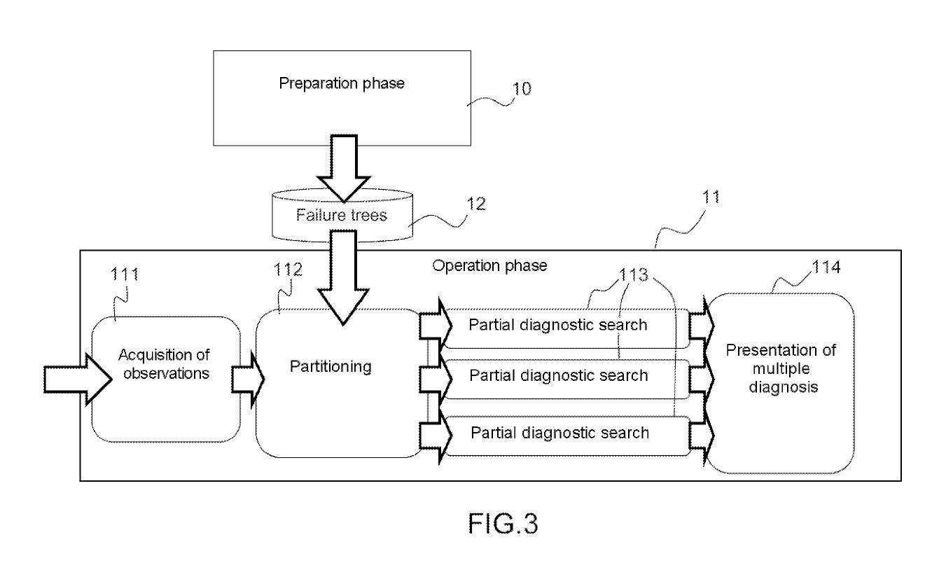

FIG. 3 shows a diagram of the method according to the invention. The method according to the invention includes a preparation phase 10, in which a set of failure trees, associated individually with each of the observable effects and an operating phase 11, is generated or output.

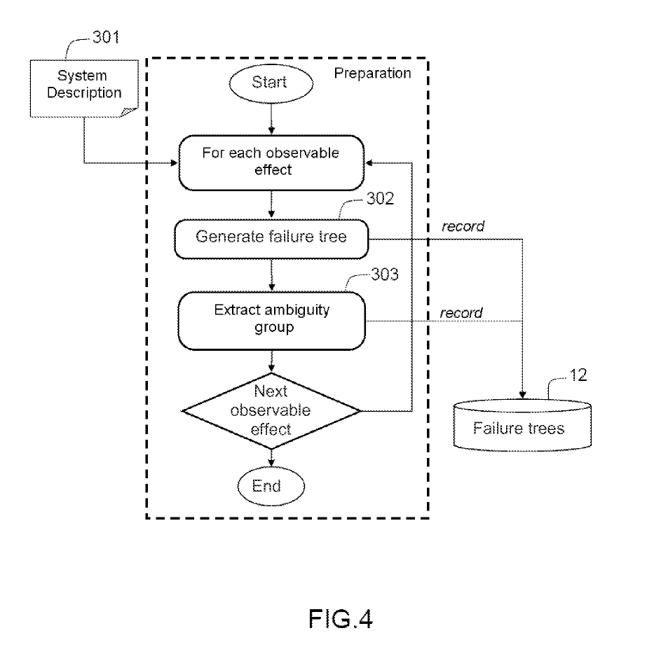

During the preparation phase, a database of failure trees 12 is constructed, containing the set of the failure trees associated with each observation. FIG. 4 shows a diagram illustrating the steps of the preparation phase. The preparation phase includes the following steps:
for each observable effect:
the determination 302 of a failure tree based on a description of the system under diagnosis 301, and the recording of the generated tree in the database of failure trees 12,
the extraction 304 of an ambiguity group from the generated failure tree and the recording of the ambiguity group in the database of failure trees 12.

The description of the system under diagnosis indicates, notably, the various elements of the system and their physical or functional relationship.

The determination of the failure trees is based on the knowledge of the relations between the failures of a component (the root cause) and the effects of these failures (FMEA—Failure Mode Effect Analysis). These relations between the failures and their effects are expressed either as logical relations or in graphic form as a failure tree (FTA—Failure Tree Analysis).

In this case, the ambiguity group is composed of the set of root causes leading to the observation.

In the preceding example, a first ambiguity group GA(P) is obtained for the observation Po, where GA(P)={a1,a2,a3}, and a second ambiguity group GA(Q) is obtained for the observation Qo, where GA(q)={b1,b2,b3}

The operation phase includes the following steps:
a step 111 of acquiring observations based on signals transmitted by the equipment of the system under diagnosis. This step determines a global situation on the basis of the acquired observations and of predetermined failure trees associated with these observations, wherein a failure tree describes relations between an observation and root causes, and a root cause indicates a failure of a piece of equipment,
a step 112 of determining connected situations, a connected situation being a set of observations which, when considered in pairs, have at least one common root cause in their failure tree,
a step 113 of determining partial diagnoses on the basis of each of the connected situations, the diagnoses including root causes associated with observations signalling a failure,
a step 114 of displaying the diagnoses.

The step 112 of determining connected situations enables the step 113 of determining the diagnosis to be simplified. This is because, when two sets of observations have no common causes, the factorization principle has no common causes to extract and is therefore not relevant. At most, the combination increases the complexity of the result.

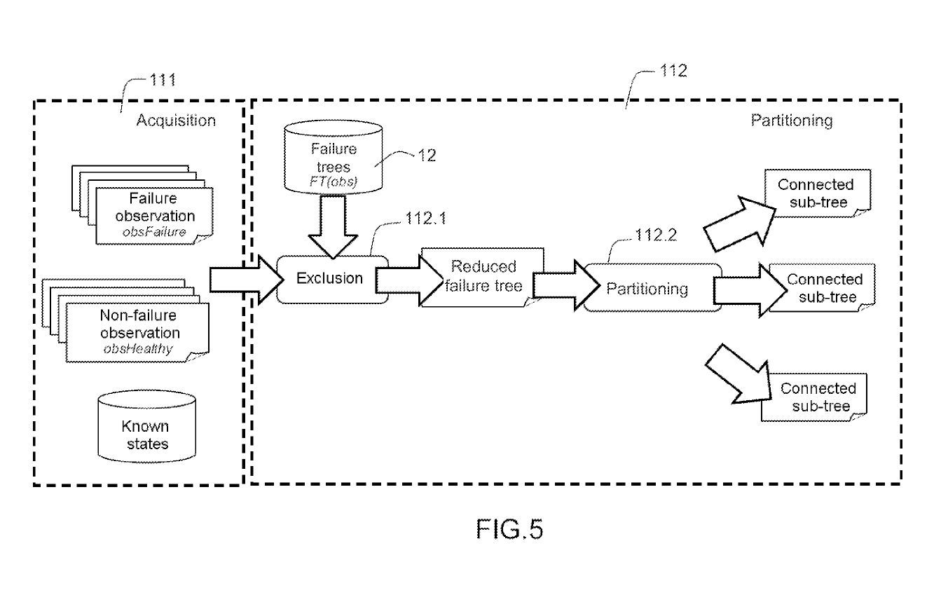

FIG. 5 shows the details of the steps of acquiring 111 and determining 112 connected situations.

The acquisition 111 includes the acquisition of observations based on signals transmitted by the equipment of the system under diagnosis. For example, for a system under diagnosis in the avionics field, the various computers are equipped with maintenance functions capable of sending messages about their operating state.

One example of a typical observation is a message containing the result of a test, which is positive if the failure has been observed, or negative in the contrary case.

The global situation will then be composed of the set of test results collected in the system, expressed as a logical combination of the various observations.

The step 112 of determining connected situations includes two sub-steps, namely an exclusion step 112.1 and a partitioning step 112.2.

The exclusion sub-step 112.1 includes the determination of a reduced failure tree for the global situation. The failure tree for the global situation is composed of the set of possible causes leading to the observation of the global situation. These possible causes include hardware failures, software errors or states of the system's environment incompatible with the operating mode of the system.

A reduced failure tree is obtained from a failure tree by removing from the tree the causes associated with effects for which the test result is negative (that is to say, the effect was not observed) and the known states of the system which could not have given rise to the situation. For example, if a situation can be created either by the failure of an altitude sensor (hardware failure) or by an “altitude too low” signal (for example, a system state in which the altitude is less than 10 metres) sent even though the aircraft is found to be flying at 10,000 metres, the cause “altitude too low” can be removed from the tree.

The reduced failure tree is therefore a failure tree in which the only remaining causes are those which cannot be eliminated by the acceptance of non-failure observations and the known states of the system under diagnosis.

The term “non-failure observations” denotes observations which have been collected during the capture step and which have a value indicating that the looked-for effect has not occurred.

Returning to the preceding example, let us assume that the first observation Po (with the first ambiguity group GA(P)={a1,a2,a3}) and the second observation Qo (with the second ambiguity group GA(Q)={b1,b2,b3}) are received. We assume that a third failure R having the ambiguity group GA(R)={a1,b1} is not observed. The causes a1 and b1 are therefore excluded. We can confirm that they have not led to the observations Po and Qo. The reduced failure tree is obtained by removing these two causes from the failure tree.

A step of partitioning is applied to the reduced failure tree. In the partitioning step 112.2, the sub-trees of failures not sharing a root cause are identified.

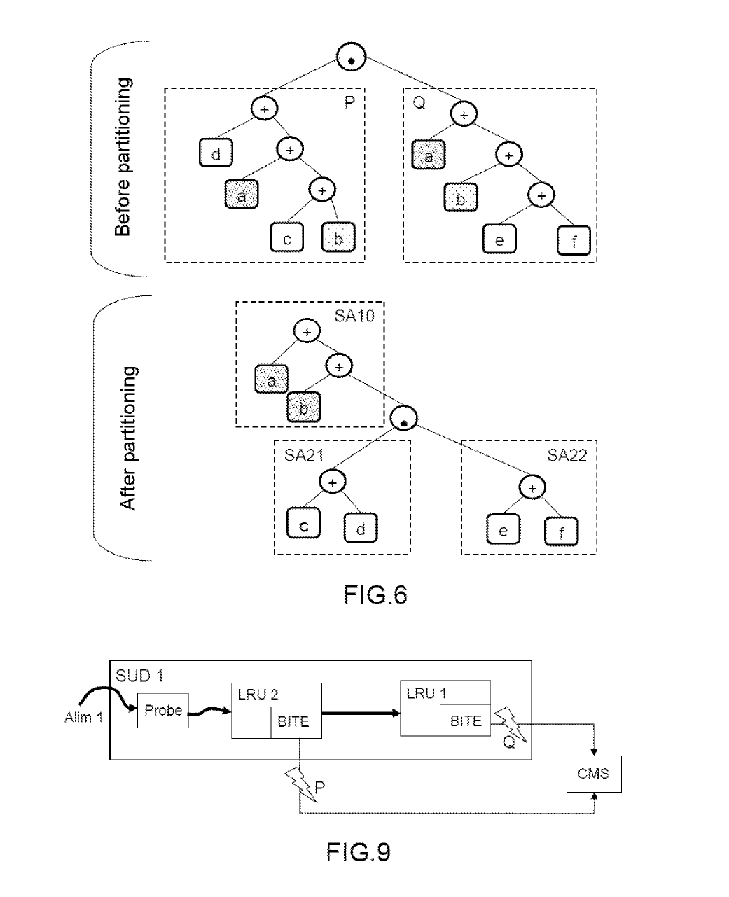

FIG. 6 shows an example of a tree before and after partitioning. In this example, a reduced failure tree is obtained, representing the situation of two observations. These two observations are associated with their respective ambiguity groups:

P=a+b+c+d and Q=a+b+e+f.

The partitioning has separated the reduced failure tree corresponding to the situation P and Q into sub-trees without common causes, namely SA10, SA21 and SA22.

A first sub-tree SA10 comprises the causes a and b, a second sub-tree SA21 comprises the causes c and d, and a third sub-tree comprises the causes e and f.

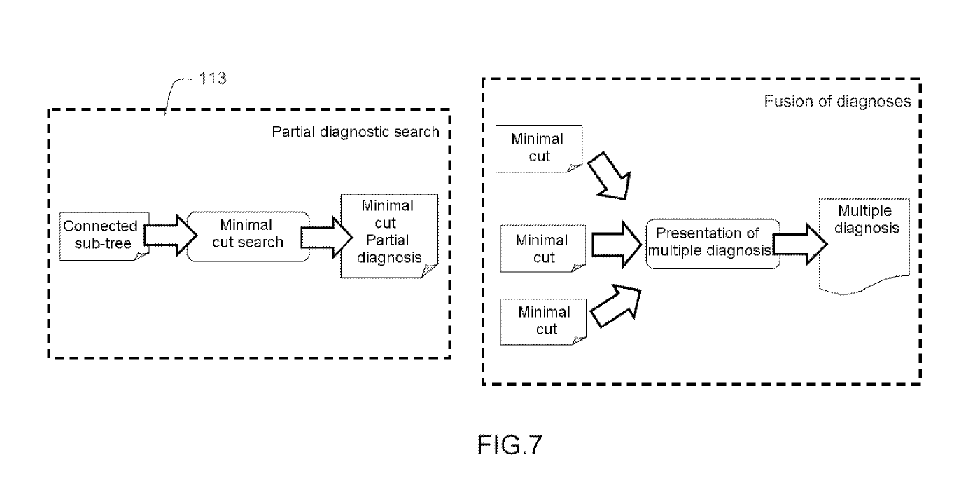

FIG. 7 shows a diagram of the steps of determination of partial diagnoses and fusion.

A minimal cut set search step is applied to each of the sub-trees.

A minimal cut set search method (also called positive cut) is described in the article Exact and truncated computations of prime implicants of coherent and non-coherent Failure Tree within Aralia (Elsevier, Éd.), Dutuit, Y., & Rauzy, A. (21 Aug. 2001). The minimal cut is termed the “minimal p-cut” in this document. “p-cut”, meaning “positive cut”, is used simply because, in the context of failures, only the positive symbols are of interest. For example, “a” signifies “failure at present” whereas “ [symbol] a” signifies “no failure a”.

In the p-cut, a purely symbolic expression is provided, expressing the fact, for example, that a situation S=a+ [symbol] b is observable if a is present or b is absent. The concept of a minimal cut can be associated with the result of the absorption property of Boolean algebra.

This is because the term “minimal cut” is applied to a failure (or a combination of failures) whose presence is sufficient to explain the observed situation. The other failures are said to be masked by this minimal failure.

FIG. 9 shows the mechanism of masking by a minimal cut. It shows an example of a system under diagnosis, SUD1, including a first computation unit LRU1 connected to a second computation unit LRU2. The second computation unit is supplied by a power supply Pwr1 through a probe denoted Probe.

The maintenance function BITE of the second computation unit LRU2 transmits the message P, signifying that LRU2 has failed or the probe Probe has failed or PWR1 has failed; that is to say, P=LRU2+Probe+PWR1.

The maintenance function BITE of the first computation unit LRU1 transmits the message Q, signifying that LRU1 has failed or LRU2 has failed; that is to say, Q=LRU1+LRU2.

The global situation S corresponds to the logical combination of the two observations P and Q.

P•Q=(LRU2+Probe+PWR1)•(LRU1+LRU2)

P•Q=(LRU2•LRU1)+(Probe•LRU1)+(PWR1•LRU1)+(LRU2•LRU2)+(Probe•LRU2)+(PWR1•LRU2)

P•Q=(LRU2•LRU2)+(LRU2•LRU1)+(Probe•LRU2)+(PWR1•LRU2)+(Probe•LRU1)+(PWR1•LRU1)

P•Q=LRU2•(1+LRU1+Probe+PWR1)+Probe•LRU1+PWR1•LRU1

P•Q=LRU2+(Probe+PWR1)•LRU1

This expression signifies that there is a single failure LRU2 and a double failure between LRU1 and an ambiguity group {Probe, PWR1}.

The expression LRU2+(Probe+PWR1)•LRU1 describes three minimal cuts {LRU2}, {LRU1, PWR1} and {LRU1, Probe}.

There is a set of failures masked by the absorption of the Boolean value 1 in (1+LRU1+Probe+PWR1). The masked group is {LRU1, Probe, PWR1}.

There is a step of fusion of the minimal cuts of each of the reduced failure trees into a multiple diagnosis.

Thus, when there are multiple failures, each associated with an ambiguity group, the result of the diagnosis conserves the ambiguity group as a unit for searching and eliminating doubt.

The fusion is carried out by combining all the partial diagnoses. In practice, the reduced failure trees are juxtaposed in the display.

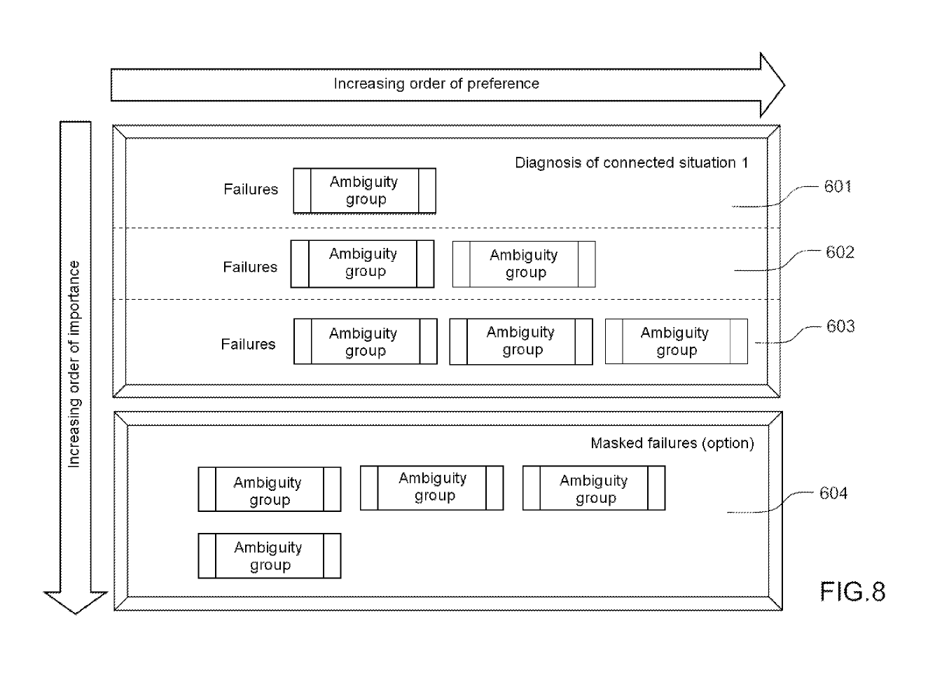

FIG. 8 shows a first example of a display according to the invention. The display is divided into a plurality of sections. Each of the sections contains diagnoses having an identical number of simultaneous causes of the observed failure.

A first section 601 is concerned with single failures, a second section 602 is concerned with double failures, and a third section 603 is concerned with triple failures.

In each of these sections, the ambiguity group are presented to the operator in an order of preference according to predefined criteria. Within each ambiguity group, the causes are arranged in order of preference according to predefined criteria, for example the cost of repair, the repair time, the likelihood of the failure, etc., as defined by the air transport company. An example of criteria for choice is given in French patent application FR 2 931 256.

Because of this display, the presentation of the multiple diagnosis is suitable for the purposes of investigation. Thus the failure search operations are targeted on each of the ambiguity groups.

This display has the advantage of being both compact and comprehensive. This is because all the diagnoses (in other words, all the logical combinations of causes of a malfunction) are displayed not explicitly, but in a factorized form which can easily be interpreted by a maintenance operator.

In a variant embodiment, the display also includes a supplementary space 604 for the display of ambiguity groups masked by the minimal cuts.

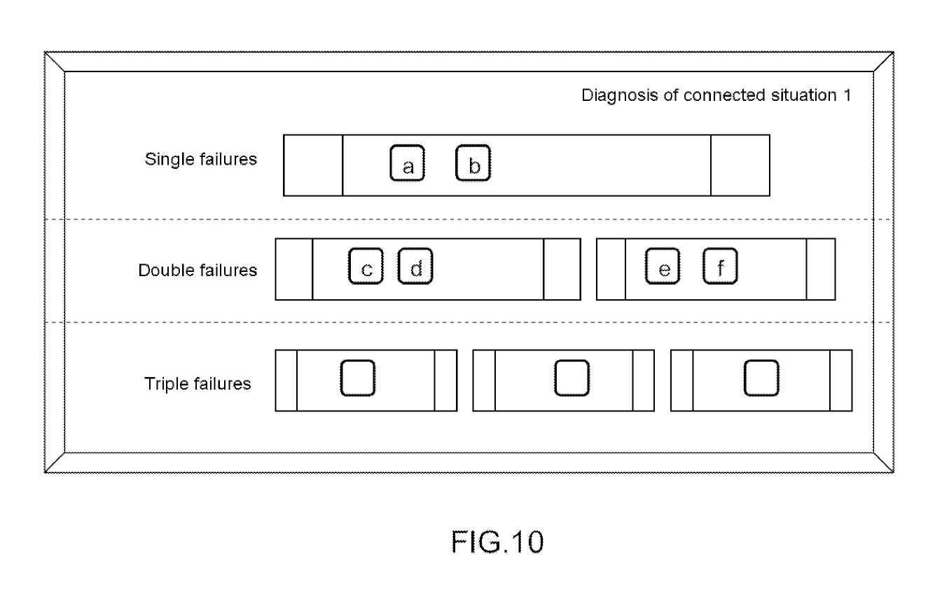

FIG. 10 shows a second example of a display according to the invention.

In this example, the first section 601 which shows single failures includes an ambiguity group comprising two causes, a and b. This means that cause a or cause b may be responsible for the observed malfunction.

The second part 602, showing double failures, contains a first and a second ambiguity group. The first ambiguity group comprises two causes, c and d. The second ambiguity group comprises two causes, e and f. This display corresponds to the following logical formula: (c+d)•(e+f). This means that (c and e) or (c and f) or (d and e) or (d and f) can be responsible for the observed malfunction.

The third section 603 shows no diagnosis.

The invention also relates to a device for determining diagnoses for a system having a plurality of pieces of equipment, the equipment being adapted to transmit signals indicating its operating state, characterized in that it includes:
means 111 for acquiring observations based on signals transmitted by the equipment of the system under diagnosis;
means for determining a global situation based on the acquired observations and on predetermined failure trees associated with these observations, where a failure tree describes relations between an observation and root causes, and a root cause indicates a failure of a piece of equipment;
means 112 for determining connected situations, where a connected situation is a set of observations which, when considered in pairs, have at least one common root cause in their failure tree;
means 113 for determining partial diagnoses based on each of the connected situations, the diagnoses including root causes associated with observations signalling a failure;
means 114 for displaying the diagnoses.

The device according to the invention is an application of the method according to the invention to a maintenance computer.

1. A method for determining diagnoses for a system having a plurality of pieces of equipment, the equipment being adapted to transmit signals indicating its operating state, comprising the following steps:
acquiring observations based on signals transmitted by the equipment of a system under diagnosis, and determining a global situation based on the acquired observations and predetermined failure trees associated with these observations, wherein a failure tree describes the relations between an observation and root causes, and a root cause indicates a failure in a piece of equipment,
determining connected situations, a connected situation being a set of observations which, when considered in pairs, have at least one common root cause in their failure tree,
determining partial diagnoses on the basis of each of the connected situations, the diagnoses including root causes associated with observations signalling a failure, and
displaying the diagnoses.

2. The method according to claim 1, wherein the step of determining connected situations includes the following sub-steps:
determination of a reduced failure tree based on the global situation and on observations indicating non-failures, the reduced failure tree being produced by removing the causes associated with non-failure observations from the global situation, and
partitioning for the purpose of determining sub-trees of failures which do not share any root causes.

3. The method according to claim 1, further comprising a preparation phase for determining a set of failure trees associated individually with each of the observable effects based on a description of the system, these trees being stored in the database of predetermined trees.

4. The method according to claim 3, wherein the preparation phase includes the following steps, for each observable effect:
generation of a failure tree based on a description of the system under diagnosis, and the recording of the generated tree in the database of failure trees,
extraction of an ambiguity group from the generated failure tree and the recording of the ambiguity group in the database of failure trees.

5. The method according to claim 1, wherein the display is divided into a plurality of sections, each of the sections including diagnoses having an identical number of simultaneous causes giving rise to the observed failure.

6. The method according to claim 5, wherein the display also includes a supplementary space for the display of masked ambiguity groups.

7. A device for determining diagnoses for a system having a plurality of pieces of equipment, the equipment being adapted to transmit signals indicating its operating state, comprising:
means for acquiring observations based on signals transmitted by the equipment of the system under diagnosis;
means for determining a global situation based on the acquired observations and on predetermined failure trees associated with these observations, wherein a failure tree describes relations between an observation and root causes, and a root cause indicates a failure of a piece of equipment;
means for determining connected situations, a connected situation being a set of observations which, when considered in pairs, have at least one common root cause in their failure tree;
means for determining partial diagnoses based on each of the connected situations, the diagnoses including root causes associated with observations signalling a failure; and
means for displaying the diagnoses.
